(19) United States
(12) Patent Application Publication
(10) Pub. No.: US 2025/0006386 A1
(43) Pub. Date: Jan. 2, 2025

(54) TEMPERATURE CONTROL DEVICE SURROUNDING EQUIPMENT PENETRATING A PRESSURIZED VESSEL

(71) Applicant: Westinghouse Electric Company LLC, Cranberry Township, PA (US)

(72) Inventors: Phillip B. SCHRUM, Jefferson Hills, PA (US); Mark A. VEROSKY, Elizabeth, PA (US); Jason S. YOUNG, Salem, OH (US)

(73) Assignee: Westinghouse Electric Company LLC, Cranberry Township, PA (US)

(21) Appl. No.: 18/346,132

(22) Filed: Jun. 30, 2023

(51) Int. Cl. G21C 11/08; G21C 13/028

(52) U.S. Cl. CPC G21C 11/08; G21C 13/0285

(57) ABSTRACT

Disclosed is a nuclear reactor, comprising: a canister, a nuclear reactor core housed inside of the canister, and a controlled temperature housing attached to the canister. The nuclear reactor core comprises a control drum and a shaft extending from the control drum and out of the nuclear reactor core. Heat generated by the nuclear reactor core enters the controlled temperature housing. The controlled temperature housing comprises a proximal end attached to the canister, a first internal plate spaced from and positioned distal to the proximal end, a second internal plate spaced from and positioned distal to the first internal plate, and a motor mounted to the second internal plate. The shaft enters the controlled temperature housing through the proximal end and extends to the motor. The controlled temperature housing is to passively maintain the motor at a temperature equal to or below a predetermined temperature threshold.

### BACKGROUND

The present disclosure relates to small module reactors and nuclear micro-reactors, or any other enclosed high temperature system, and the temperature sensitive equipment inside them.

### SUMMARY

In one general aspect, the present disclosure provides a nuclear reactor. The nuclear reactor comprises a canister and a nuclear reactor core housed inside of the canister. The nuclear reactor core comprises a control drum and a shaft extending from the control drum and out of the nuclear reactor core. The nuclear reactor further comprises a controlled temperature housing attached to the canister, wherein heat generated by the nuclear reactor core enters the controlled temperature housing. The controlled temperature housing comprises a proximal end attached to the canister, a first internal plate spaced from and positioned distal to the proximal end, a second internal plate spaced from and positioned distal to the first internal plate, and a motor mounted to the second internal plate. The shaft enters the controlled temperature housing through the proximal end and extends to the motor. The motor is operably coupled to the shaft. The controlled temperature housing is to passively maintain the motor at a temperature equal to or below a predetermined temperature threshold.

In at least one aspect, the controlled temperature housing defines an internal space, wherein the first internal plate spans across the internal space, and wherein the second internal plate spans across the internal space.

In at least one aspect, a coupling interface is added where the first internal plate meets an exterior wall of the controlled temperature housing and where the second internal plate meets the exterior wall of the controlled temperature housing.

In at least one aspect, the controlled temperature housing comprises a multi-layer insulation positioned against internal surfaces of the controlled temperature housing to reduce emissivity.

In at least one aspect, the controlled temperature housing comprises a coating applied to internal surfaces of the controlled temperature housing to reduce emissivity.

In at least one aspect, the controlled temperature housing further comprises: a base plate located at the proximal end, wherein the base plate is attached to the nuclear reactor; and a support member extending from the base plate to the second internal plate, wherein the support member is to support and attach the first internal plate and the second internal plate to the base plate. In at least one aspect, the controlled temperature housing further comprises an external housing surrounding the first internal plate and the second internal plate, wherein a first gap is defined between the first internal plate and the external housing, and wherein a second gap is defined between the second internal plate and the external housing. In at least one aspect, the external housing is removable.

In at least one aspect, the proximal end defines a first hole, wherein the first internal plate defines a second hole aligned with the first hole, and wherein the shaft extends through the first hole and the second hole. In at least one aspect, the shaft extends through a seal before exiting the nuclear reactor core. In at least one aspect, the canister maintains a working fluid at a first pressure, wherein the controlled temperature housing maintains the working fluid at a second pressure, and wherein in an equilibrium state of the nuclear reactor the first pressure is equal to the second pressure. In at least one aspect, in a non-equilibrium state of the nuclear reactor defined by the first pressure being greater than the second pressure, the pressurized gas in the nuclear reactor core enters the controlled temperature housing until the equilibrium state is reached. In at least one aspect, in a non-equilibrium state of the nuclear reactor defined by the first pressure being less than the second pressure, the pressurized gas in the controlled temperature housing enters the nuclear reactor core until the equilibrium state is reached.

In at least one aspect, the controlled temperature housing is an annular housing.

In at least one aspect, the predetermined temperature threshold is 250 Fahrenheit.

In at least one aspect, the shaft comprises a shaft thermal break, a proximal shaft comprising a distal end coupled to the shaft thermal break, and a distal shaft comprising a proximal end coupled to the shaft thermal break.

In at least one aspect, the controlled temperature housing is one of a plurality of control temperature housings attached to the canister.

In another aspect, the present disclosure provides a controlled temperature housing for temperature sensitive equipment attached to a container housing a heat generation source. Heat generated by the heat generation source enters the controlled temperature housing from the container. The controlled temperature housing comprises a proximal end attached to the container, a thermal shield plate spaced from and positioned distal to the proximal end, and a temperature sensitive equipment mounting plate spaced from and positioned distal to the thermal shield plate. A temperature sensitive device is mounted on a distal side of the temperature sensitive equipment mounting plate. The controlled temperature housing is to passively cool the heat from the container to maintain a temperature at the temperature sensitive device equal to or below a predetermined temperature threshold.

In at least one aspect, a shaft extends from the temperature sensitive equipment and into the container.

In another aspect, the present disclosure provides a pressurized high temperature device. The pressurized high temperature device comprising a container housing a heat generation source and a controlled temperature housing attached to the container. Heat generated by the heat generation source enters the controlled temperature housing. The controlled temperature housing comprises a proximal end attached to the container, a thermal shield plate spaced from and positioned distal to the proximal end, a temperature sensitive equipment mounting plate spaced from and positioned distal to the thermal shield plate, and a temperature sensitive device mounted to the temperature sensitive equipment mounting plate. The temperature sensitive device is coupled to another device in the container through a hole that extends through the proximal end of the controlled temperature housing and into the container. The controlled temperature housing is to passively cool the heat to maintain a temperature at the temperature sensitive device equal to or below a predetermined temperature threshold. The pressurized high temperature device further comprises a pressurized working fluid. The container maintains the pressurized working fluid at a first pressure. The controlled temperature housing maintains the pressurized working fluid at a second pressure. In an equilibrium state the first pressure is equal to the second pressure.

### BRIEF DESCRIPTION OF THE FIGURES

The novel features of the various aspects are set forth with particularity in the appended claims. Throughout the FIGS. like reference characters designate like or corresponding parts throughout the several views of the drawings. The described aspects, however, both as to organization and methods of operation, may be best understood by reference to the following description, taken in conjunction with the accompanying drawings in which:

FIG. 1 is a perspective view of a nuclear micro-reactor, according to at least one aspect of the present disclosure.

FIG. 2 is a perspective view of a nuclear micro-reactor core, according to at least one aspect of the present disclosure.

FIG. 3 is a cross-section view of the nuclear micro-reactor of FIG. 1, according to at least one aspect of the present disclosure.

FIG. 4 is a schematic of the nuclear micro-reactor of FIG. 1, according to at least one aspect of the present disclosure.

FIG. 5 is a detailed view of FIG. 4 that illustrates an example a shaft seal, according to at least one aspect of the present disclosure.

FIG. 6 is a perspective view of a controlled temperature housing, according to at least one aspect of the present disclosure.

FIG. 7 is a cross-sectional view of the controlled temperature housing of FIG. 6 taken along cross-sectional lines 7-7, according to at least one aspect of the present disclosure.

FIG. 8 is a cross-sectional view of the controlled temperature housing of FIG. 6 taken along cross-sectional lines 7-7, according to at least one aspect of the present disclosure.

FIG. 9 is a cross-sectional view of the controlled temperature housing taken along cross-sectional lines 7-7 and illustrating support features, according to at least one aspect of the present disclosure.

FIG. 10 is a cross-sectional view of the controlled temperature housing taken along cross-sectional lines 7-7 and illustrating support features, according to at least one aspect of the present disclosure.

FIG. 11 is a schematic of an example coupling interface of FIGS. 10 and 11, according to at least one aspect of the present disclosure.

FIG. 12 is a cross-sectional view of the controlled temperature housing illustrating a shaft thermal break, according to at least one aspect of the present disclosure.

FIG. 13 is a cross-sectional view of the controlled temperature housing illustrating a shaft thermal break, according to at least one aspect of the present disclosure.

FIG. 14 is a perspective view of a nuclear micro-reactor, according to at least one aspect of the present disclosure.

FIG. 15 is a cross-sectional view of a controlled temperature housing of FIG. 14, according to at least one aspect of the present disclosure.

FIG. 16 is a cross-sectional view of a controlled temperature housing of FIG. 14 illustrating support features, according to at least one aspect of the present disclosure.

### DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “top”, “bottom”, “forward”, “rearward”, “left”, “right”, “upwardly”, “downwardly”, and the other such words are words of convenience and are not to be construed as limiting terms.

It should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

During operation of a nuclear reactor, the temperature inside of the nuclear reactor core can reach temperatures as high as 800-12000. The temperature of the nuclear reactor core can be too high for the operation of some needed electronic equipment. For example, stepper motors that rotate a control drum inside of a nuclear reactor and control drum electro-mechanical equipment, e.g. electro-mechanical latches, need to be kept at temperatures below 250° F. As such, there is some electronic equipment that must be kept within a controlled temperature environment to avoid overheating any of the electronic equipment.

A solution to this issue is to use a controlled temperature housing that creates a controlled temperature environment around the electronic equipment to keep temperatures below a predetermined threshold during operation of a nuclear reactor, e.g. below 250° F. In at least one aspect, the controlled temperature housing passively creates the controlled temperature environment. In at least one aspect, the controlled temperature housing is designed to minimize the mass and volume of the housing while still passively creating a temperature controlled environment. In some aspects, the controlled temperature housing is part of the canister, or container, that houses a nuclear reactor core. In these aspects, the design keeps any working fluid, e.g. helium, of the nuclear reactor core environment from leaking to the environment outside of the nuclear reactor.

The controlled temperature housing can provide a plurality of benefits. In at least one aspect, the controlled temperature housing provides a temperature controlled environment, needed for the temperature sensitive electronic components, inside of the canister of the nuclear reactor. In at least one aspect, the design limits any leakage of the working fluid, making up the internal reactor core environment, out of the reactor core environment to the outside environment. In at least some aspects, there is a supply of the working fluid that supplies the reactor core with the needed environment work fluid, e.g. helium gas. The design and placement of the controlled temperature housing minimizes any leakage of the working fluid and as such reduces the size of the working fluid supply that is needed. Additionally, the controlled temperature housing is configured to passively create a temperature controlled environment which is more efficient than requiring an active cooling system, e.g. powered system, to generate the temperature controlled environment. In at least some aspects, the temperature controlled environment being created passively reduces the overall size and mass of the controlled temperature housing since it does not require any additional active components for cooling the temperature controlled environment.

While the controlled temperature housing is discussed in connection to a nuclear reactor, e.g. a nuclear micro-reactor, the housing can be connected to any enclosed high temperature system, including non-micro-reactors. For example, the housing can be house high temperature non-nuclear boilers or other high temperature industrial applications, which require temperature sensitive control equipment that passes structurally through a pressurized boundary to attach to some in-vessel components to perform a function. In at least one aspect, the controlled temperature housing is used with a high temperature industrial application where a rotating shaft must pass through a pressured vessel boundary into a high temperature environment.

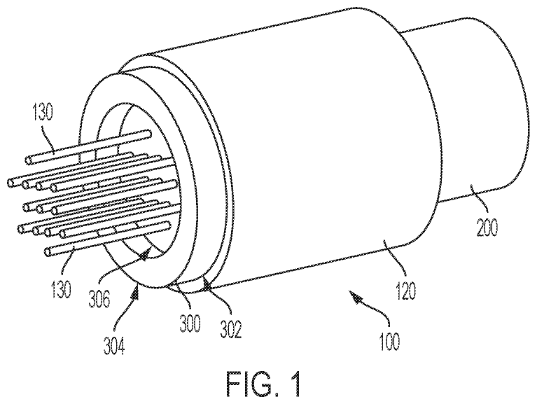

FIG. 1 is a perspective view of a nuclear micro-reactor, according to at least one aspect of the present disclosure. The nuclear micro-reactor includes a reactor core 100 enclosed in a canister, or container, 120, a controlled temperature housing 300, a heat exchanger 200, and shutdown rod housings 130. The controlled temperature housing 300 has a proximal end 302 and a distal end 304, where the proximal direction is defined as toward the reactor core 100 and the distal direction is defined as away from the reactor core 100. The proximal end 302 of the controlled temperature housing 300 is attached to the canister 120. In at least one aspect, the controlled temperature housing 300 becomes part of the canister 120. In at least one aspect, the controlled temperature housing 300 is an annular housing. In this aspect, the shutdown rod housings 130 attach to the canister 120 through the opening 306 in the middle of the controlled temperature housing 300. While the controlled temperature housing 300 is shown as an annular housing, this is not the only shape that could be used for the controlled temperature housing 300. The controlled temperature housing 300 could be any exterior shape. If the controlled temperature housing 300 is not annular, then the shutdown rod housings 130 could attached to the controlled temperature housing 300.

The controlled temperature housing 300 is designed to house electronic components toward the distal end 304 at a temperature equal to or below a predetermined threshold. In at least one aspect, the temperature is below 250° F. The heat generated during operation of the nuclear reactor core 100 enters the controlled temperature housing 300 on the proximal end 302 and the heat is passively cooled, e.g. by external heat transfer from natural convection through the inner wall 324, the outer wall 326, and end plate 322, such that the internal temperature toward the distal end 304 is at or below the predetermined threshold. In at least one aspect, the temperature that the reactor core reaches is 800-12000. While it is envisioned that active cooling on the outside surface of the controlled temperature housing 300 could be used to cool the internal temperature, the controlled temperature housing 300 is designed such that active cooling is not required for the internal temperature toward the distal end 304 to be equal to or below the predetermined threshold.

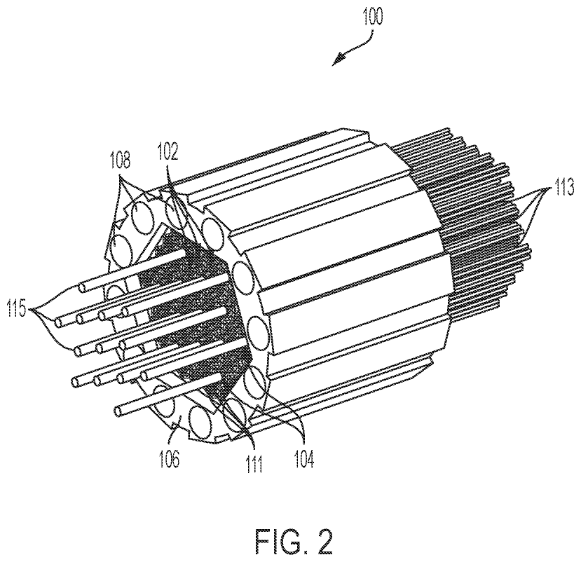

FIG. 2 is a perspective view of the reactor core 100, according to at least one aspect of the present disclosure. The nuclear micro-reactor uses heat pipes 113 to transfer heat energy from the reactor core 100 to the heat exchanger 200. The nuclear micro-reactor is a transportable micro-reactor that is inherently simpler and smaller than previous conventional reactors due to a solid state design. There are a limited number of moving parts within the reactor core 100 and minimal required maintenance between refueling. Decay heat is removed via natural convection and radiation heat transfer.

Referring to FIG. 2, the reactor core 100 can be assembled to include fuel 111 (e.g. rods and/or stacks of pellets), heat pipes 113, and reactivity shutdown rods 115 dispositioned throughout the plurality of unit cells 102 and reactivity control unit cells 104. In at least one aspect, the reactivity shutdown rods 115 are housed in the shutdown rod housings 130. Specifically, the fuel 111 can be dispositioned throughout fuel channels of one or more unit cells 102, the heat pipes 113 can be dispositioned throughout heat pipe channels of one or more unit cells 102, and the reactivity shutdown rods 115 can be dispositioned through a reactivity control channel (not shown) of one or more reactivity control cells 104. According to some non-limiting aspects, the fuel 111 and heat pipes 113 are configured to extend the length of the reactor core 100. In other non-limiting aspects, the heat pipes 113 are configured to extend an additional length beyond the length of the reactor core 100, to facilitate downstream ex-core connections and/or equipment (e.g. heat exchanger 200, power conversion systems, condensers, structural supports). This design allows the reactor core 100 to be customized for a wide range of intended applications and/or user preferences, which enables it to be versatile in response to customer needs. The assembled reactor core 100 design of FIG. 2 allows the fuel 111 and heat pipes 113 to be specifically configured to accommodate for a wide range of specific power requirements and/or structural configurations without having to reinvent the basic reactor core 100 design and assume the inherent development risks.

In further reference to FIG. 2, the neutron reflector 106 can further include a plurality of control drums 108 configured to house a neutron absorptive and reflective materials. In the event of a reactor and/or power failure, the control drums 108 can turn inward towards the reactor core 100 such that the absorptive material to shut down the reactor core 100 is turned inward. According to a non-limiting aspect of FIG. 2, the neutron reflector 106 can further include a gamma shield configured to substantially surround a neutron shield, the reactor core 100, and its internal components 102, 104, 111, 113, 115 to further mitigate radiation.

Still referring to FIG. 2, the reactor core 100 can further include a plurality of shutdown rods 115 configured to be dispositioned through a reactivity control cell 104 of the plurality of reactivity control cells 104. For example, the reactivity control cells 104 can include a shutdown rod 115 or shutdown channel similar to the fuel channels and/or heat pipe channels, but specifically configured to accommodate a shutdown rod 115. Each shutdown rod 115 can include a neutron absorbing material configured to slow and/or stop the nuclear reactions within the reactor core 100 in the case of an emergency. The shutdown rods 115 can collectively work to prevent the reactor core 100 from achieving a temperature above a structural temperature threshold or reduce reactivity in the event of a reactor and/or power failure.

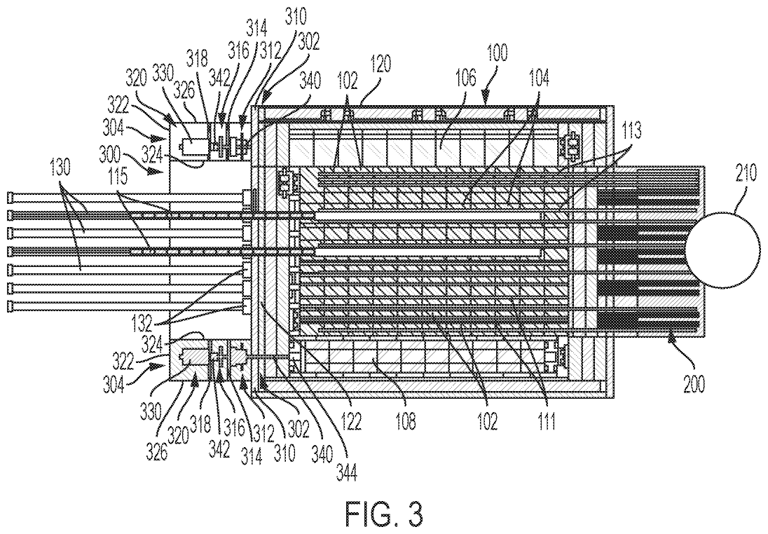

FIG. 3 is a cross-sectional view of the nuclear micro-reactor of FIG. 1, according to at least one aspect of the present disclosure. The plurality of unit cells 102 and the plurality of reactivity control unit cells 104 are stacked to create a monolith inside of the reactor core 100. The heat pipes 113 extend from the reactor core 100 into the heat exchanger 200. The reactor core 100 has fuel 111 that is retained within the reactor core 100. In one aspect, the shutdown rods 115 are moved by an energy storage system, e.g. a spring or compressive gas, which applies a force in an accident/emergency scenario to insert the shutdown rods 115 into the reactor core 100 to slow/stop the nuclear reactions within the reactor core 100. In an alternative aspect, the shutdown rods 115 are moved by motors, where each motor can move one shutdown rod 115 into the reactor core 100 to slow/stop the nuclear reactions within the reactor core 100. Sensors 132 are configured to detect the position of a shutdown rod 115. The canister 120 is connected to a working fluid charging tank 210, e.g. a helium charging tank, which supplies and pressurizes the canister 120, which is the pressure boundary container for the working fluid. The reactor core 100 is located within the pressurized environment within the canister 120, which provides an appropriate internal reactor core environment.

The controlled temperature housing 300 has a motor 330 mounted to a motor mounting plate 318. The internal temperature of the controlled temperature housing 300 at the motor 330 is kept at or below the predetermined threshold during operation of the nuclear micro-reactor. The motor 330 is connected to a shaft 340 by a motor coupling 342. The shaft 340 extends through the controlled temperature housing 300 and into the reactor core 100 to operably couple to a control drum 108 by a control drum coupling 344. A rotation of the motor 330 causes the control drum 108 to rotate.

The controlled temperature housing 300 is an extension of the canister 120 housing the reactor core 100 in a pressurized vessel environment. This design reduces working fluid leakage from the canister 120 environment to the external environment by containing it in an enclosed volume. For example, if the motor 330 was located outside of the canister 120 with a rotating shaft seal positioned where the shaft 340 enters the reactor core 100, without the controlled temperature housing 300, then there could be an excessive amount of leakage of the working fluid through the shaft seal to the external environment. However, with the controlled temperature housing 300 being designed as an extension of the canister 120, any leakage of the working fluid where the shaft 340 enters the reactor core 100 is contained within the controlled temperature housing 300, as opposed to leaking to the external environment. Additionally, in at least one aspect, the annular design of the controlled temperature housing 300 creates an opening in the middle in order to situate the shutdown rod housings 130 outside of this environment to avoid additional penetrations.

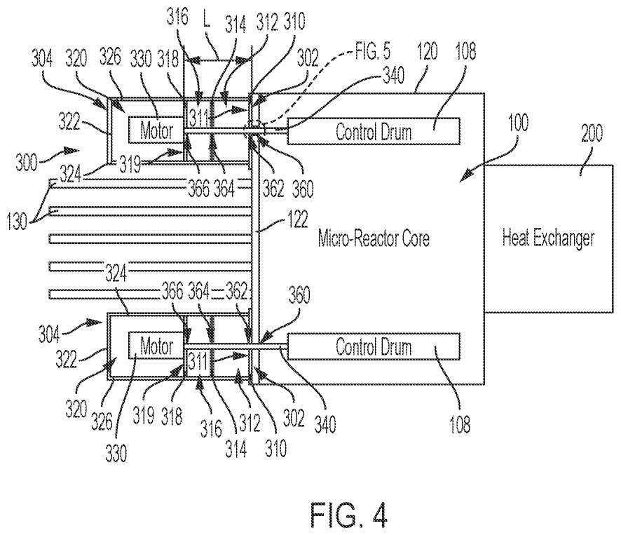

FIG. 4 illustrates a simplified schematic of the nuclear micro-reactor of FIG. 1, according to at least one aspect of the present disclosure. Referring to FIGS. 3 and 4, the controlled temperature housing 300 has a base plate 310 that is attached to the canister 120 on the proximal end 302 with a distal side 311 of the base plate 310 facing away from the reactor core 100. In at least one aspect, the controlled temperature housing 300 has an inner wall 324 and an outer wall 326 extending distally away from the base plate 310. At the distal end 304 of the controlled temperature housing 300 there is an end plate 322 that is attached to the inner wall 324 and the outer wall 326 forming the enclosure of the controlled temperature housing 300. The controlled temperature housing 300 has a thermal shield plate 314 spaced from and positioned distal to the base plate 310. The thermal shield plate 314 is attached to the inner wall 324 and the outer wall 326 such that the thermal shield plate 314 spans the distance between the inner wall 324 and the outer wall 326 forming a first internal space 312. The motor mounting plate 318 is spaced from and positioned distal to the thermal shield plate 314. The motor mounting plate 318 is attached to the inner wall 324 and the outer wall 326 such that the motor mounting plate 318 spans the distance between the inner wall 324 and the outer wall 326 forming a second internal space 316 and a third internal space 320. The third internal space 320 is distal to the second internal space 316 and the second internal space 316 is distal to the first internal space 312. While the controlled temperature housing 300 is shown having 2 internal plates 314, 318, any number of internal plates could be added inside of the controlled temperature housing 300.

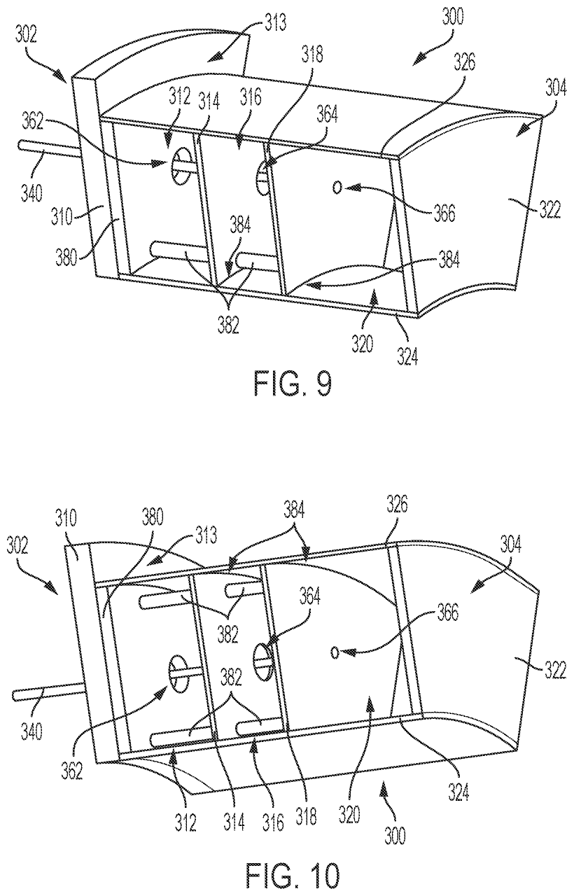

In at least one aspect, the thermal shield plate 314 and the motor mounting plate 318 are both welded to the inner wall 324 and the outer wall 326. In an alternative aspect, the thermal shield plate 314 and the motor mounting plate 318 have a gap between them and the inner wall 324 and the outer wall 326. In this aspect, the thermal shield plate 314 and the motor mounting plate 318 are supported by support members attached to the base plate 310, e.g. support member 382 described in regard to FIGS. 9 and 10. Having a gap between the internal plates 314, 318 and the inner and outer walls 324, 326 can allow easy access for assembly and disassembly of the controlled temperature housing 300. For example, the gap can allow for the inner components, e.g. the base plate 310, thermal shield plate 314, and the motor mounting plate 318, of the controlled temperature housing 300 to be attached to the canister 120 without an external housing, e.g. inner wall 324, outer walls 326, and end plate 322, attached. In this aspect, the motor 330 and the shaft 340 can be attached without the inner wall 324, the outer wall 326, and the end plate 322 attached. Once the motor 330 and shaft 340 are coupled inside of the controlled temperature housing 300 and any other components are connected and/or attached to the interior of the controlled temperature housing 300, e.g. insulation or coatings, then the inner wall 324, the outer wall 326, and the end plate 322, can be attached to the control temperature housing 300. This process can allow a user easy access to the internal components of the control temperature housing 300 and allows for easy assembly and disassembly of the controlled temperature housing 300 required for any component installations, maintenance, and/or repairs.

In at least one aspect, the motor 330 is mounted to the motor mounting plate 318 on a distal side 319 of the motor mounting plate 318 in the third internal space 320. The temperature in the third internal space and the temperature at the mounting location on the motor mounting plate 318 are either at or below the predetermined temperature threshold during operation of the nuclear micro-reactor. In at least one aspect, the distance L between the motor mounting plate 318 and the reactor core 100 relates to the temperature at the motor. For example, increasing the distance L can decrease the temperature at the motor since it places the motor farther away from the reactor core 100 and the heat generated by the reactor core 100 during operation. Correspondingly, decreasing the distance L can increase the temperature at the motor since it places the motor closer to the reactor core 100. In at least one aspect, the distance L was minimized to lower the mass and volume of the controlled temperature housing 300, while maintaining the temperature at the motor to be at or below the predetermined temperature threshold.

Referring primarily to FIGS. 3 and 4, as discussed above the motor 330 is attached to a shaft 340 that extends from the motor 330 inside of the controlled temperature housing 300 to the control drum 108 inside of the reactor core 100. A motor shaft 332 (FIG. 12) of the motor 330 extends through a hole 366 in the motor mounting plate 318 to a motor coupling 342 that operably couples the motor shaft 332 to the shaft 340. The shaft 340 extends through a hole 364 in the thermal shield plate 314 and through a hole 362 in the base plate 310. When the controlled temperature housing 300 is attached to the canister 120, holes 362 in the base plate 310 line up with holes 360 in a wall 122 in the canister 120. As such, the shaft 340 extends through a hole 360 in the wall 122 to the control drum 108. In at least one aspect, a rotation of the shaft 340 by the motor 330 causes the control drum 108 to also rotate.

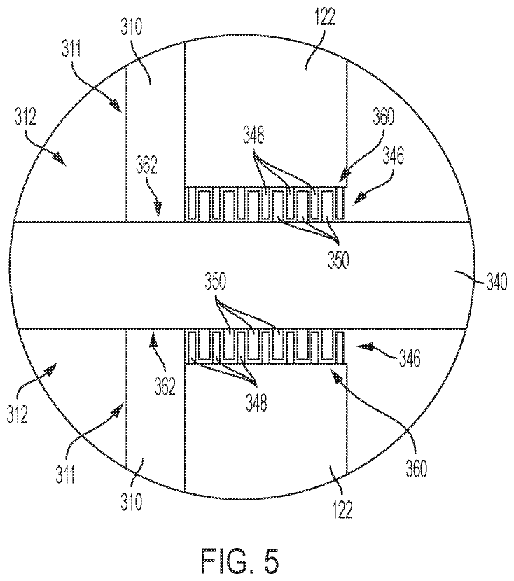

In at least one aspect, the shaft 340 extends through a seal in the hole 360. FIG. 5 is a detailed view of FIG. 4 that illustrates an example shaft seal 346, according to at least one aspect of the present disclosure. The shaft seal 346 is configured to limit the amount of working fluid that moves between the reactor core 100 and the controlled temperature housing 300. In at least one aspect, the shaft seal 346 is a rotating seal that creates a path that limits the amount of fluid flow between the reactor core 100 and the controlled temperature housing 300. For example, the shaft seal 346 could be a labyrinth seal. In at least one aspect, the fluid flow path could help to avoid ingress of hotter working fluid from the reactor core 100 to the controlled temperature housing 300. In at least one aspect, the shaft seal 346 includes first seal components 348 attached to the hole 360 and second seal components 350 attached to the shaft 340, such that the shaft 340 rotates the second seal components 350 within the spaces defined by the first seal components 348. The working fluid can move between the reactor core 100 and the controlled temperature housing 300 through the space defined between the first seal components 348 and the second seal components 350. In at least one aspect, the seal is configured to control the rate of working fluid inflow into the controlled temperature housing 300 so as to not allow a large temperature fluctuation due to the movement of working fluid into the controlled temperature housing 300.

In at least one aspect, the controlled temperature housing 300 is used as a pressure control feature for the reactor core 100 environment by the exchange of working fluid between the reactor core 100 and the controlled temperature housing 300. For example, the working fluid inside of the controlled temperature housing 300 can be at a first pressure and the working fluid inside of the reactor core 100 can be at a second pressure. In at least one aspect, the nuclear micro-reactor is in an equilibrium state when the first pressure equals the second pressure. When the nuclear micro-reactor is in a non-equilibrium state, the nuclear micro-reactor passively moves toward the equilibrium state. In at least one aspect, the nuclear micro-reactor is in a non-equilibrium state defined by the first pressure being greater than the second pressure. In this aspect, the working fluid in the controlled temperature housing 300 moves into the reactor core 100 to equalize the first pressure and the second pressure and to place the nuclear micro-reactor in the equilibrium state. In an alternative aspect, the nuclear micro-reactor is in a non-equilibrium state defined by the second pressure being greater than the first pressure. In this aspect, the working fluid in the reactor core 100 moves into the controlled temperature housing 300 to equalize the first pressure and the second pressure and to place the nuclear micro-reactor in the equilibrium state.

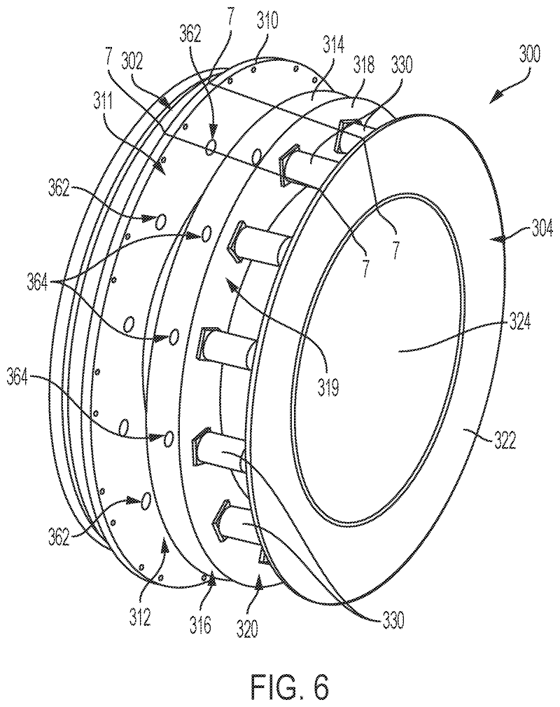

FIG. 6 is a perspective view of the controlled temperature housing 300, according to at least one aspect of the present disclosure. FIG. 6 shows the controlled temperature housing 300 with the outer wall 326 removed. The controlled temperature housing 300 houses a plurality of motors 330 that are connected to shafts (not shown) that extend to control drums 108 in the reactor core 100 as described above in regard to FIGS. 3 and 4. In at least one aspect, each hole 362 in the base plate 310 allows some amount of working fluid to leak into the controlled temperature housing 300 from the reactor core 100. The controlled temperature housing 300 is designed to minimize any working fluid leakage to the outside environment and to keep the working fluid inside the canister 120 and controlled temperature housing 300. As described above in regard to FIG. 5, the working fluid can move back and forth between the reactor core 100 and the controlled temperature housing 300 through the holes 362.

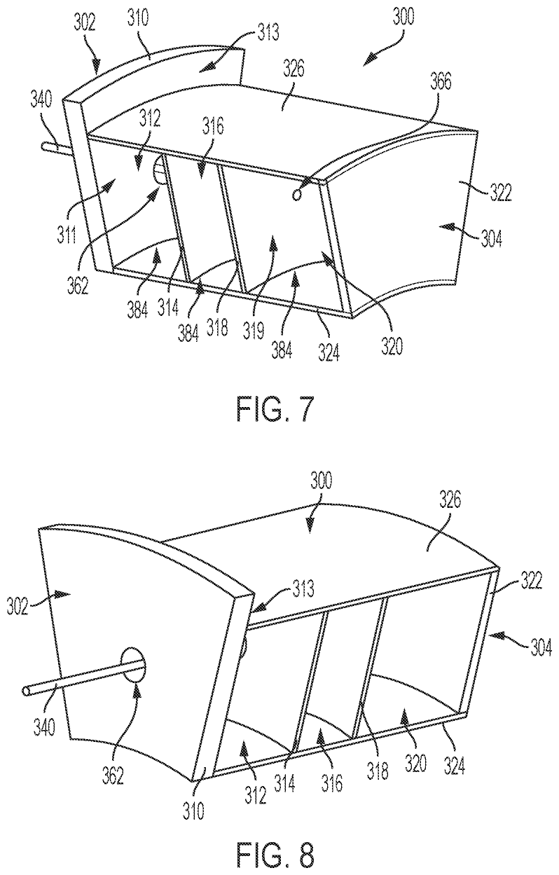

FIGS. 7 and 8 are cross-sectional views of the controlled temperature housing 300 taken along cross-sectional lines 7-7. As described above in regard to FIGS. 3 and 4, the base plate 310 is attached to the reactor core 100 on the proximal end 302. In at least one aspect, the base plate includes an outer edge portion 313 that extends outside of the outer wall 326. During operation of the nuclear micro-reactor, heat is generated at the reactor core 100 and the heat transfers to the controlled temperature housing 300 by conduction heat transfer and radiation heat transfer. For example, the heat enters the controlled temperature housing 300 by conduction heat transfer through the base plate 310 which also heats the inner wall 324 and outer wall 326. The heat can also radiate through the first internal space 312, the second internal space 316, and the third internal space 320. In at least one aspect, as heat is being transferred to the controlled temperature housing 300, the heat is passively removed from the controlled temperature housing 300 by convection heat transfer to the outside environment through the inner wall 324, outer wall 326, and end plate 322. In at least one aspect, enough heat is passively removed to maintain the temperature at the motor to at or below the predetermined temperature threshold. In at least one aspect, the distance L (FIG. 4) is determined such that the controlled temperature housing 300 passively removes enough heat to maintain the temperature at the motor at or below the predetermined temperature threshold as described in greater detail above in regard to FIG. 4.

The controlled temperature housing 300 is designed to help reduce heat transfer from the reactor core 100 and promote passive heat transfer away from the controlled temperature housing 300. In at least one aspect, the controlled temperature housing 300 is made of stainless steel, C-103 Niobium, Ultramet C-C Zirconium Carbide, Novoltex Sepcarb, and/or Iridium/Rhenium. The thermal shielding plate 314 is designed to shield some of the radiation heat transfer in the first internal space 312 from entering farther into the controlled temperature housing 300. In at least one aspect, the thermal shielding plate 314 is made of a common material, e.g. stainless steel, and thermal shielding plate 314 has a high conductivity interface between the thermal shielding plate 314 and the inner and outer walls 324, 326, e.g. coupling interface 384 described in FIGS. 9-11. The high conductivity interface can help to pull heat from the thermal shielding plate 314 to the inner and outer walls 324, 326, where the heat can be dispersed to the outside environment through convection heat transfer out of the inner and outer walls 324, 326. Additionally and/or alternatively, the thermal shielding plate 314 can be made of a material with a low emissivity to further reduce the amount of radiation heat transferred through that material.

In at least one aspect, multi-layer insulation is placed on all the internal surfaces of the controlled temperature housing 300 to reduce the emissivity which reduces the radiation heat transfer into the controlled temperature housing 300. For example, the multi-layer insulation can be a foil. Additionally, or alternatively, a coating can be placed on the internal and/or external surfaces of the controlled temperature housing 300 to reduce the emissivity which reduces the radiation heat transfer into the controlled temperature housing 300. In at least one aspect, the multi-layer insulation and/or the coating are not placed on the inner wall 324 and outer wall 326 surfaces to promote convection heat transfer out of the controlled temperature housing 300.

FIGS. 9 and 10 are cross-sectional views of the controlled temperature housing 300 taken along cross-sectional lines 7-7 and illustrating support features, according to at least one aspect of the present disclosure. In at least one aspect, the controlled temperature housing 300 can further reduce heat transfer into the controlled temperature housing 300 by placing an thermal conductive shield 380, or insulation layer, against the distal side 311 of the base plate 310. As shown in FIGS. 9 and 10, the hole 362 extends through the thermal conductive shield 380. For example, this thermal conductive shield 380 can reduce the heat transfer into the controlled temperature housing 300 by blocking some of the heat entering the controlled temperature housing 300 through the base plate 310. For example the insulation can be one of, or a combination of, Excelfrac 1800 board, Microsil, ZYFB-3, Duraboard 2600, Pyro-Log H, Microcal 1100, AL-30, and Saffil. In this aspect, the base plate 310 would get hotter and pass some of that heat to the inner wall 324 and outer wall 326 through conduction heat transfer, where that heat would then move away from the controlled temperature housing 300 through convection heat transfer from the inner wall 324 and outer wall 326 to the external environment. In some aspects, the base plate 310 is designed to allow some heat to move away from the controlled temperature housing 300 through convection heat transfer from the outer edge portion 313 of the base plate 310 to the external environment.

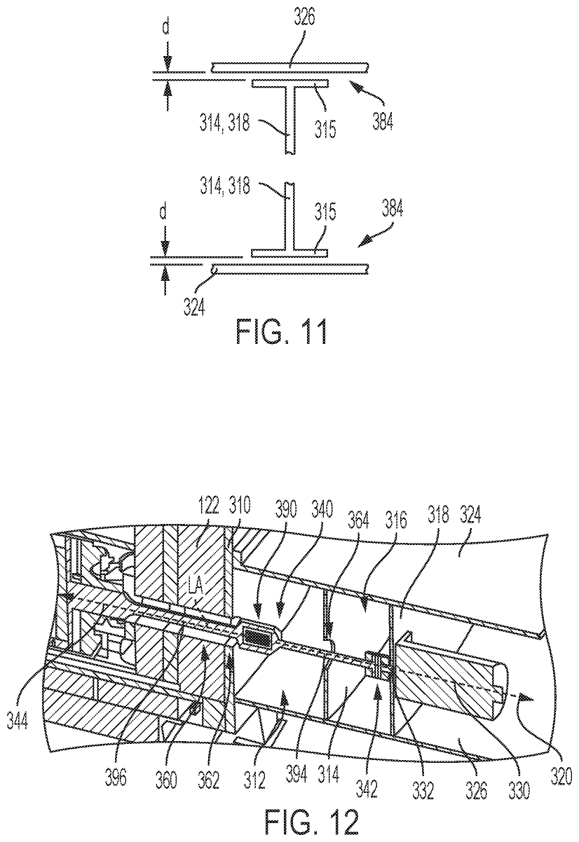

In at least one aspect, a coupling interface 384 is placed between the connection between the thermal shield plate 314 and the inner wall 324, the connection between the thermal shield plate 314 and the outer wall 326, the connection between the motor mounting plate 318 and the inner wall 324, and the connection between the motor mounting plate 318 and the outer wall 326. Stated another way, additional material can be added to the connection where the thermal shield plate 314 meets the inner wall 324 and the outer wall 326, and additional material volume can be added to the connection where the motor mounting plate 318 meets the inner wall 324 and the outer wall 326. In at least one aspect, the coupling interface 384 could be stainless steel added between the internal plates 314, 318 and the inner wall 324 and the outer wall 326. For example, a coupling interface 384 of stainless steel could be created between the thermal shield plate 314 and the inner wall 324 by welding the thermal shield plate 314 to the inner wall 324 and adding additional stainless steel can enlarge the connection between the thermal shield plate 314 and the inner wall 324. In at least one aspect, the internal plates 314, 318 include a lip 315 (FIG. 11), where the distance “d” is zero, such that the lip 315 rests against either the inner wall 324 or the outer walls 326 to increase the contact area between the internal plates 314, 318 and the inner and outer walls 324, 326.

In at least one aspect, there is a gap between the internal plates 314, 318 and the inner and outter walls 324, 326. In this aspect, the coupling interface 384 is the working fluid, e.g. helium, which can move between the reactor core 100 and the controlled temperature housing 300. As such, heat is conductively transferred from the internal plates 314, 318 to the inner and outer walls 324, 326 through the working fluid. FIG. 11 illustrates a schematic of an example coupling interface, e.g. coupling interface 384, of FIGS. 9 and 10, according to at least one aspect of the present disclosure. The gap has a distance “d” between the internal plates 314, 318 and the inner and outer walls 324, 326. In at least one aspect, the distance “d” can be decreased to increase the conductive interface between the internal plates 314, 318 and the inner and outer walls 324, 326. As discussed previously, having a gap between the internal plates 314, 318 and the inner and outer walls 324, 326 can provide easy assembly and disassembly of the controlled temperature housing 300 for installation of components, maintenance, and/or repairs. In at least one aspect, the coupling interface 384 includes a lip 315 on the edges of the internal plates 314, 318. For example, the lip 315 can increase the near-contact area between the internal plates 314, 318 and the inner and outer walls 324, 326. While FIG. 11 illustrates the lip 315 on both sides of the internal plates 314, 318, the lip 315 could be on only one side of the internal plates 314, 318. In at least one aspect, the lip 315 is made of the same material as the internal plates 314, 318, e.g. stainless steel.

In at least one aspect, the coupling interface 384 promotes conductive heat transfer from the thermal shield plate 314 to the inner wall 324, from the motor mounting plate 318 to the inner wall 324, from the thermal shield plate 314 to the outer wall 326, and from the motor mounting plate 318 to the outer wall 326. For example, enlarging the coupling interface 384 could promote more conductive heat transfer through the coupling interface 384. The conductive heat transfer takes heat from the internal components of the controlled temperature housing 300 and directs it toward the inner wall 324 and the outer wall 326 to be removed through convection heat transfer to the external environment.

Referring to FIGS. 9 and 10, in at least one aspect, the motor mounting plate 318 and the thermal shield plate 314 have support members 382 that attach the motor mounting plate 318 and the thermal shield plate 314 to the base plate 310. The support members 382 are configured to structurally support the motor mounting plate 318 and the thermal shield plate 314. In at least one aspect, the support members 382 allow for a gap between the internal plates 314, 318 and the inner and outer walls 324, 326. In at least one aspect, the support members 382 allow for the thermal shield plate 314 and the motor mounting plate 318 to be attached to the base plate 310 without the inner wall 324, outer wall 326, and end plate 322. In this aspect, the inner wall 324, outer wall 326, and end plate 322 can form an external housing that can be attached to the base plate 310 after internal components, e.g. shaft 340, motor 330, and etc., of the controlled temperature housing 300 are installed. This process can provide easy access for assembly and disassembly of the controlled temperature housing 300. In at least one aspect, the support members 382 are made of a low conductivity material to minimize the amount of conduction heat transfer from the base plate 310 through the support members 382 into the controlled temperature housing 300. For example, the support members 382 can be made of Zirconia or another low conductivity material.

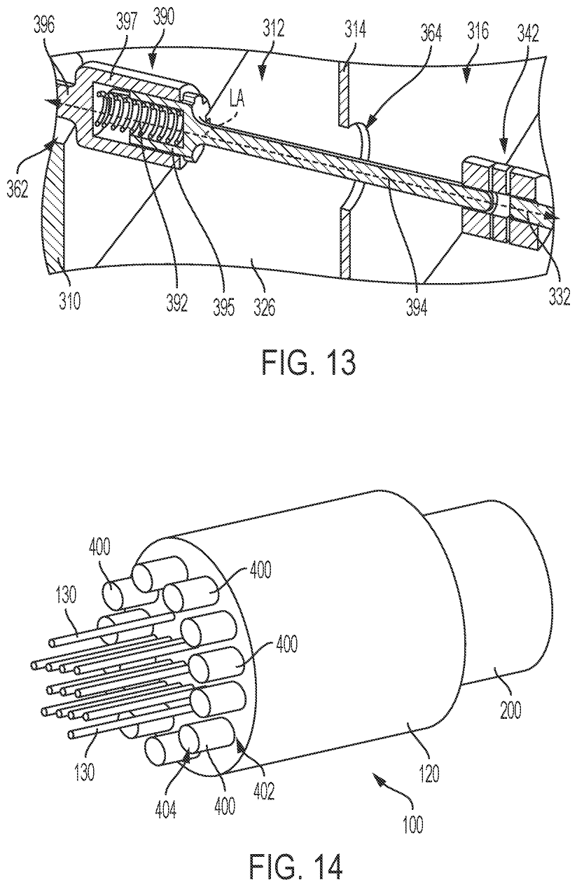

FIGS. 12 and 13 are cross-sectional views of the controlled temperature housing 300 illustrating a shaft thermal break 390, according to at least one aspect of the present disclosure. In at least one aspect, the shaft 340 has a shaft thermal break 390 to reduce the amount of conduction heat transfer through the shaft 340. For example, the conduction heat transfer can be reduced by causing a break in the shaft 340. In this aspect, the shaft 340 defines a longitudinal axis LA and has a proximal shaft 396 and a distal shaft 394. The proximal shaft 396 extends from the control drum 108 inside of the reactor core 100 and into the controlled temperature housing 300. A distal end 397 of the proximal shaft 396 couples with a proximal end 395 of the distal shaft 394 at the shaft thermal break 390 such that the proximal shaft 396 and/or the distal shaft 394 can move in either direction along the longitudinal axis LA. In at least one aspect, the shaft thermal break 390 has a biasing member 392 between the proximal shaft 396 and the distal shaft 394. For example, when the shaft is installed between the motor 330 and the control drum 108, the biasing member 392 can be configured to apply a force to the proximal shaft 396 and the distal shaft 394 that presses the proximal shaft 396 toward the control drum 108 and the distal shaft 394 toward the motor 330. In at least one aspect, the heat generated by the reactor core 100 causes the proximal shaft 396 and/or the distal shaft 394 to expand, or contract, along the longitudinal axis LA. For example, the addition of heat to the shaft 340 can cause the shaft 340 to expand and the removal of heat from the shaft 340 can cause the shaft 340 to contract. In this instance, the shaft thermal break 390 allows the proximal shaft 396 and the distal shaft 394 to move along the longitudinal axis LA reducing any stresses caused by thermal expansion of proximal shaft 396 and/or the distal shaft 394.

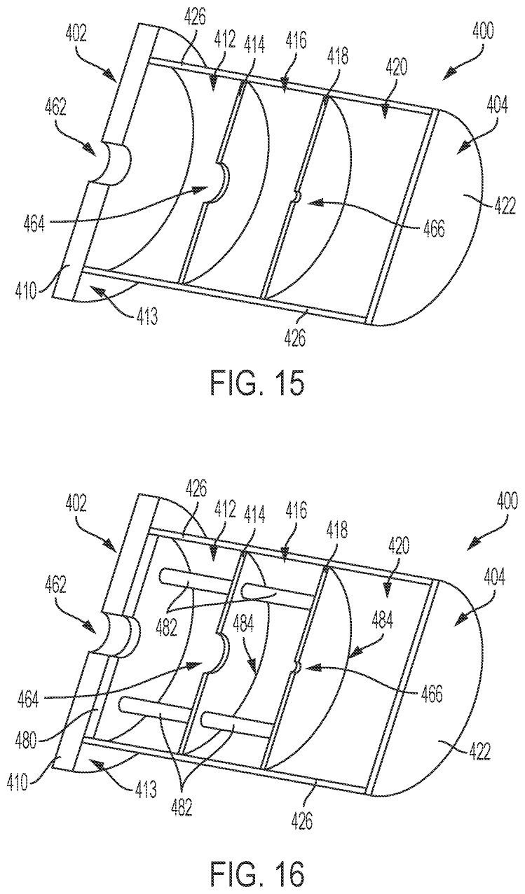

FIG. 14 is a perspective view of nuclear micro-reactor 100 with a plurality of temperature control housings 400 attached, FIG. 15 is a cross-sectional view of a controlled temperature housing 400 of FIG. 14 and FIG. 16 is a cross-sectional view of a controlled temperature housing 400 of FIG. 14 illustrating support features, each according to at least one aspect of the present disclosure. Each control temperature housing 400 of the plurality of controlled temperature housings is similar in many respects to control temperature housing 300. For example, a proximal end 402, a distal end 404, a base plate 410, a first internal space 412, an outer edge portion 413, a thermal shielding plate 414, a second internal space 416, a motor mounting plate 418, a third internal space 420, an end plate 422, an outer wall 426, a hole 462, a hole 464, a hole 466, a thermal conductive shield 480, a support member 482, and a coupling interface 484 function the same and are substantially similar to the proximal end 302, the distal end 304, the base plate 310, the first internal space 312, the outer edge portion 313, the thermal shielding plate 314, the second internal space 316, the motor mounting plate 318, the third internal space 320, the end plate 322, the outer wall 326, the hole 362, the hole 364, the hole 366, the thermal conductive shield 380, the support member 382, and the coupling interface 384, respectively. For the sake of brevity, not all similar features and components will be discussed in detail.

Similar to controlled temperature housing 300, each controlled temperature housing 400 has a motor 330 attached to the motor mounting plate 418, where a motor shaft extends through the hole 466 to couple to the shaft 340, not shown in FIGS. 15 and 16. The shaft 340 extends through the hole 464 in the thermal shield plate 414, through the hole 462 in the base plate 310, and through the hole 360 in the wall 122 of the canister 120 to reach and couple to a control drum 108 inside of the canister 120.

The controlled temperature housing 400 differs from controlled temperature housing 300 in that each control drum motor 330 has a separate controlled temperature housing 400, and in the controlled temperature housing 300 all of the control drum motors 330 are inside of the controlled temperature housing 300 as shown in FIG. 6. Referring to FIG. 14, the proximal end 402 of each controlled temperature housing 400 is attached to the canister 120. In at least one aspect, each controlled temperature housing 400 becomes part of the canister 120. In at least one aspect, each controlled temperature housing 400 is cylindrical. While the controlled temperature housings 400 are shown as cylindrical housings, this is not the only shape that could be used for the controlled temperature housing 400. The controlled temperature housings 400 can be any exterior shape.

Each controlled temperature housing 400 is designed to house electronic components toward the distal end 404 at a temperature equal to or below a predetermined threshold. In at least one aspect, the predetermined temperature threshold is 250° F. Similar to control temperature housing 300, the heat generated during operation of the nuclear reactor core 100 enters each controlled temperature housing 400 on the proximal end 402 and the heat is passively cooled, e.g. by external heat transfer from natural convection through the outer wall 426 and end plate 422, such that the internal temperature toward the distal end 404 is at or below the predetermined threshold.

Similar to control temperature housing 300, control temperature housing 400 includes the thermal shield plate 414 and the motor mounting plate 418. In at least one aspect, the internal plates 414, 418 are both welded to the outer wall 426. In an alternative aspect, the internal plates 414, 418 have a gap between them and the outer wall 426. In this aspect, the thermal shield plate 414 and the motor mounting plate 418 are supported by the support members 482 attached to the base plate 410. Having a gap between the internal plates 414, 418 and the outer wall 426 can allow easy access for assembly and disassembly of the controlled temperature housing 400. For example, the outer wall 426 and end plate 422 can form an external housing that can be attached to the base plate 410 after internal components, e.g. shaft 340, motor 330, and etc., to the controlled temperature housing 400 are installed. While the controlled temperature housing 400 is shown having 2 internal plates 414, 418, any number of internal plates could be added inside of the controlled temperature housing 400.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The aspects described herein are understood as providing illustrative features of varying detail of various aspects of the present disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the present disclosure. Accordingly, it will be recognized by persons having ordinary skill in the art that various substitutions, modifications or combinations of any of the exemplary aspects may be made without departing from the scope of the invention. In addition, persons skilled in the art will recognize, or be able to ascertain using no more than routine experimentation, many equivalents to the various aspects of the present disclosure described herein upon review of this specification. Thus, the present disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those aspects where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those aspects where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all aspects by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

What is claimed is:

1. A nuclear reactor, comprising:
a canister;
a nuclear reactor core housed inside of the canister, the nuclear reactor core comprising:
a control drum; and
a shaft extending from the control drum and out of the nuclear reactor core; and
a controlled temperature housing attached to the canister, wherein heat generated by the nuclear reactor core enters the controlled temperature housing, and wherein the controlled temperature housing comprises:
a proximal end attached to the canister;
a first internal plate spaced from and positioned distal to the proximal end;
a second internal plate spaced from and positioned distal to the first internal plate; and
a motor mounted to the second internal plate, wherein the shaft enters the controlled temperature housing through the proximal end and extends to the motor, wherein the motor is operably coupled to the shaft, and wherein the controlled temperature housing is to passively maintain the motor at a temperature equal to or below a predetermined temperature threshold.

2. The nuclear reactor of claim 1, wherein the controlled temperature housing defines an internal space, wherein the first internal plate spans across the internal space, and wherein the second internal plate spans across the internal space.

3. The nuclear reactor of claim 1, wherein a coupling interface is added where the first internal plate meets an exterior wall of the controlled temperature housing and where the second internal plate meets the exterior wall of the controlled temperature housing.

4. The nuclear reactor of claim 1, wherein the controlled temperature housing comprises a multi-layer insulation positioned against internal surfaces of the controlled temperature housing to reduce emissivity.

5. The nuclear reactor of claim 1, wherein the controlled temperature housing comprises a coating applied to internal surfaces of the controlled temperature housing to reduce emissivity.

6. The nuclear reactor of claim 1, wherein the controlled temperature housing further comprises:
a base plate located at the proximal end, wherein the base plate is attached to the nuclear reactor; and
a support member extending from the base plate to the second internal plate, wherein the support member is to support and attach the first internal plate and the second internal plate to the base plate.

7. The nuclear reactor of claim 6, wherein the controlled temperature housing further comprises an external housing surrounding the first internal plate and the second internal plate, wherein a first gap is defined between the first internal plate and the external housing, and wherein a second gap is defined between the second internal plate and the external housing.

8. The nuclear reactor of claim 7, wherein the external housing is removable.

9. The nuclear reactor of claim 1, wherein the proximal end defines a first hole, wherein the first internal plate defines a second hole aligned with the first hole, and wherein the shaft extends through the first hole and the second hole.

10. The nuclear reactor of claim 9, wherein the shaft extends through a seal before exiting the nuclear reactor core.

11. The nuclear reactor of claim 10, wherein the canister maintains a working fluid at a first pressure, wherein the controlled temperature housing maintains the working fluid at a second pressure, and wherein in an equilibrium state of the nuclear reactor the first pressure is equal to the second pressure.

12. The nuclear reactor of claim 11, wherein in a non-equilibrium state of the nuclear reactor defined by the first pressure being greater than the second pressure, the working fluid in the nuclear reactor core enters the controlled temperature housing until the equilibrium state is reached.

13. The nuclear reactor of claim 11, wherein in a non-equilibrium state of the nuclear reactor defined by the first pressure being less than the second pressure, the working fluid in the controlled temperature housing enters the nuclear reactor core until the equilibrium state is reached.

14. The nuclear reactor of claim 1, wherein the controlled temperature housing is an annular housing.

15. The nuclear reactor of claim 1, wherein the predetermined temperature threshold is 250 Fahrenheit.

16. The nuclear reactor of claim 1, wherein the shaft comprises:
a shaft thermal break;
a proximal shaft comprising a distal end coupled to the shaft thermal break; and
a distal shaft comprising a proximal end coupled to the shaft thermal break.

17. The nuclear reactor of claim 1, wherein the controlled temperature housing is one of a plurality of control temperature housings attached to the canister.

18. A controlled temperature housing for temperature sensitive equipment, wherein the controlled temperature housing is attached to a container housing a heat generation source, wherein heat generated by the heat generation source enters the controlled temperature housing from the container, and wherein the controlled temperature housing comprises:
a proximal end attached to the container;
a thermal shield plate spaced from and positioned distal to the proximal end; and
a temperature sensitive equipment mounting plate spaced from and positioned distal to the thermal shield plate, wherein a temperature sensitive device is mounted on a distal side of the temperature sensitive equipment mounting plate, and wherein the controlled temperature housing is to passively cool the heat from the container to maintain a temperature at the temperature sensitive device equal to or below a predetermined temperature threshold.

19. The controlled temperature housing of claim 18, wherein a shaft extends from the temperature sensitive equipment and into the container.

20. A pressurized high temperature device, comprising:
a container housing a heat generation source;
a controlled temperature housing attached to the container, wherein heat generated by the heat generation source enters the controlled temperature housing, and wherein the controlled temperature housing comprises:
a proximal end attached to the container;
a thermal shield plate spaced from and positioned distal to the proximal end;
a temperature sensitive equipment mounting plate spaced from and positioned distal to the thermal shield plate; and
a temperature sensitive device mounted to the temperature sensitive equipment mounting plate, wherein the temperature sensitive device is coupled to another device in the container through a hole that extends through the proximal end of the controlled temperature housing and into the container, and wherein the controlled temperature housing is to passively cool the heat to maintain a temperature at the temperature sensitive device equal to or below a predetermined temperature threshold; and
a pressurized working fluid, wherein the container maintains the pressurized working fluid at a first pressure, wherein the controlled temperature housing maintains the pressurized working fluid at a second pressure, and wherein in an equilibrium state the first pressure is equal to the second pressure.
